(19) United States
(12) Patent Application Publication
(10) Pub. No.: US 2007/0139686 A1
(43) Pub. Date: Jun. 21, 2007

(54) Image forming apparatus setting with a memory device mounted on a detachable member

(75) Inventor: Toshitsugu Nishimi, Chuo-ku (JP)

Correspondence Address: JORDAN AND HAMBURG LLP, 122 EAST 42ND STREET, SUITE 4000, NEW YORK, NY, 10168, US

(73) Assignee: KYOCERA MITA CORPORATION, Chuo-ku (JP)

(21) Appl. No.: 11/640,591

(22) Filed: Dec. 18, 2006

(30) Foreign Application Priority Data
Dec. 16, 2005 (JP) 2005-364014
Dec. 16, 2005 (JP) 2005-364015
Dec. 16, 2005 (JP) 2005-364016
Dec. 16, 2005 (JP) 2005-364017

(51) Int. Cl. G06F 3/12

(52) U.S. Cl. 358/1.13; 358/1.15

(57) ABSTRACT

A member unit such as the paper feeding cassette 15 attached to the image forming apparatus 1 is mounted with the RFID 13 as a memory device that stores information necessary for a language setting and a local setting, while a reader 11 that reads the RFID as the memory device is attached to the image forming apparatus. When the image forming apparatus is activated, the reader 11 reads information from the RFID 13 to perform the language setting and the local setting of the image forming apparatus 1 in accordance with the information. Accordingly, only with the paper feeding cassette 15 to which is attached the RFID 13 storing information corresponding to a region where the image forming apparatus is used, a step of the language setting and the like by a menu operation through an operation panel can be eliminated.

### BACKGROUND OF THE INVENTION

1. Field of the Invention

The present invention relates to an image forming apparatus such as a copying machine, a printer, a facsimile and a multiple function processing machine having those functions. More specifically, the present invention relates to an image forming apparatus to be localized by using a memory device.

2. Description of Related Art

The image forming apparatus such as the copying machine, the printer, the facsimile and the multiple function processing machine having those functions is manufactured so as to include a specification applicable in a lot of regions in order to have the apparatus adapt to an environment of a region where the apparatus is used, such as a language, a temperature and a humidity. And, there is a need for changing those various settings so as to be applicable in each region before the image forming apparatus is used there. Therefore, before the image forming apparatus is handed to a user, there is required a process to perform the localization of the apparatus with regard to a language, a region, and a built-in printer language in order to adapt the apparatus with the shipped region, or these settings should be done by the user before he uses the apparatus.

In order to perform these settings of the apparatus, the apparatus is to be unpacked before it is shipped, activated by being connected to a power source, and provided with the localization thereof such as a language setting using an operation panel when the apparatus is up and run. Further, in a case where the user performs the localization thereof by himself, he used to have a difficulty in operating a menu of the apparatus in an unfamiliar language in order to change the language setting.

Further, in a case of the apparatus which does not include the operation panel, the user should prepare a personal computer as an administration terminal device in order to achieve these settings, and startup and connect the image forming apparatus to the administration terminal device for changing these settings, which might be troublesome to the user.

To resolve these problems, Japanese Patent Laying-open Publication No. 2004-347940 discloses such a method that information stored in the memory device, attached to a replaceable consumable unit of the image forming apparatus, is read by the image forming apparatus body in order to set a temperature condition, a paper thickness, and a displayed language of the region where the image forming apparatus is shipped to and used.

Further, Japanese Patent Laying-open Publication No. 2005-244489 discloses such a method that, when the user operates the multiple function processing machine, information stored in a memory card held by an operator is read by the multiple function processing machine, and an output form that is set in accordance with an user identification information identified by the memory card is selected to change the display of the operation panel.

According to the method of the Japanese Patent Laying-open Publication No. 2004-347940, the temperature condition of the region where the apparatus is used, the paper thickness, and the display language can be set; however, the internal language setting for printing report, and the language setting to be used in communication with the administration terminal device should still be done through the operation panel or through the connection with the administration terminal device.

Further, according to the method of the Japanese Patent Laying-open Publication No. 2005-244489, only changes of the output form and the language display of the operation panel could be done, but a localization of the multiple function processing machine such as the internal language setting should be done by the user himself.

### SUMMARY OF THE INVENTION

An object of the present invention is to enable a local setting of an internal data of the image forming apparatus without a necessity of operation by an operation panel or an administration terminal device.

In order to achieve the above stated object, the present invention is directed to store data of the local setting of the internal data of the image forming apparatus in a memory device provided on a detachable member, in which the data is read out by a reader mounted on the image forming apparatus body to set the local setting of the internal data of the image forming apparatus.

Another object of the present invention is to enable a setting of a printer language of the internal data without a necessity of operation by the operation panel or the administration terminal device.

In order to achieve the object, the printer language setting of the internal data of the image forming apparatus is stored in the memory device provided on a detachable member, and the data is read out by the reader mounted on the image forming apparatus body to set the printer language of the internal data of the image forming apparatus.

Further another object of the present invention is to enable a setting of the internal data of the image forming apparatus without a necessity of operation of the operation panel or the administration terminal device.

In order to achieve the object, the setting of the internal data of the image forming apparatus is stored in a memory device provided on a detachable non-consumable member, and the data is read out by the reader mounted on the image forming apparatus body to set the internal data of the image forming apparatus.

Yet further object of the present invention is to enable a setting of a printer controlling code of the internal data of the image forming apparatus without a necessity of operation of the operation panel or the administration terminal apparatus.

In order to achieve the object, the setting of the internal data of the image forming apparatus is stored within the memory device provided on the detachable member, and the data is read out by the reader mounted on the image forming apparatus body to set the printer controlling code of the internal data of the image forming apparatus.

### BRIEF DESCRIPTION OF THE DRAWINGS

FIG. 1 is a configuration view of an image forming apparatus providing a RFID as a memory device according to the present invention on a paper feeding cassette.

FIG. 2 is an explanatory view indicating a position of the paper feeding cassette where the RFID according to an embodiment of FIG. 1 is mounted, the cassette being detached from the image forming apparatus.

FIG. 3 is an explanatory view of the RFID.

FIG. 4 is a block diagram of the present invention.

FIG. 5 is a flow chart explaining an operation of the image forming apparatus according to a first embodiment and a fourth embodiment.

FIG. 6 is a data that is stored in the RFID according to the first embodiment and the fourth embodiment.

FIG. 7 is a local code table that is stored in the main memory unit according to the first embodiment and the fourth embodiment.

FIG. 8 is a massage table that is stored in the main memory unit according to the first embodiment and the fourth embodiment.

FIG. 9 is an explanatory view indicating how the local code table and the message code table of the internal data according to the first embodiment and the fourth embodiment are renewed.

FIG. 10 is a report in Japanese indicating an apparatus condition according to the first embodiment and the fourth embodiment.

FIG. 11 is a report in US English indicating an apparatus condition according to the first embodiment and the fourth embodiment.

FIG. 12 is a directory configuration of a built-in web server according to the first embodiment and the fourth embodiment.

FIG. 13 is a view of the image forming apparatus including a RFID reader according to a second embodiment attached to a side surface of a power source cable insertion.

FIG. 14 is a view of the image forming apparatus including the RFID according to the second embodiment attached to the power source cable.

FIG. 15 is a flow chart explaining an operation of the image forming apparatus according to a third embodiment.

FIG. 16 is a data stored in the RFID according to the third embodiment.

FIG. 17 is an explanatory view indicating how a setting of a printer language table of the internal data according to the third embodiment is renewed.

FIG. 18 is a flow chart of an operation of the image forming apparatus according to a fifth embodiment.

FIG. 19 is a data stored in the RFID according to the fifth embodiment.

FIG. 20 is an explanatory view indicating how a setting table of a printer controlling code of the internal data according to the fifth embodiment is renewed.

### DETAILED DESCRIPTION

Configuration of the Apparatus

According to a first embodiment, it is explained that a RFID is mounted on a paper feeding cassette, with the RFID being as a detachable non-consumption member.

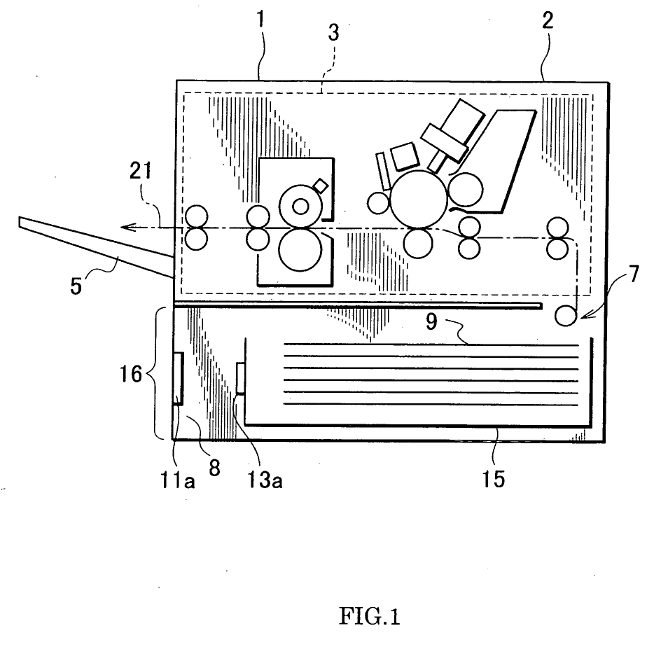

FIG. 1 illustrates a configuration of the apparatus according to the first embodiment of the present invention. An image forming apparatus 1 includes a printing unit 3 which performs a printing within a space as enclosed by a dotted line in the upper area of a housing 2. A side surface of the housing 2 is mounted with a paper discharging tray 5 which receives a printed paper. A paper feeding side of the printing unit 3 has a paper feeding unit 7 which feeds a paper to the printing unit 3.

A lower section of the housing 2 includes a cassette housing 8 formed therein. The cassette housing 8 contains a paper feeding cassette 15 which is freely detachable member. The paper feeding cassette 15, which takes a roll of keeping papers 9, is mounted with a RFID 13a as a memory device for storing information necessary for a local setting. The paper feeding cassette 15 can be inserted into/withdrawn from a cassette housing 8 from a right side in FIG. 1. The cassette housing 8 of the housing 2 is mounted at a rear wall 16 thereof with a RFID reader 11a as a reader. This RFID reader 11a is positioned so as to face to the RFID 13a when the paper feeding cassette 15 with the RFID 13a is inserted into the cassette housing 8.

When printing operation is performed by the present apparatus, the papers 9 is conveyed from the paper feeding cassette 15 through a paper feeding unit 7 along a paper conveying path 21, and further through the printing unit 3 for printing thereon to be discharged from a paper discharging tray 5 after printed.

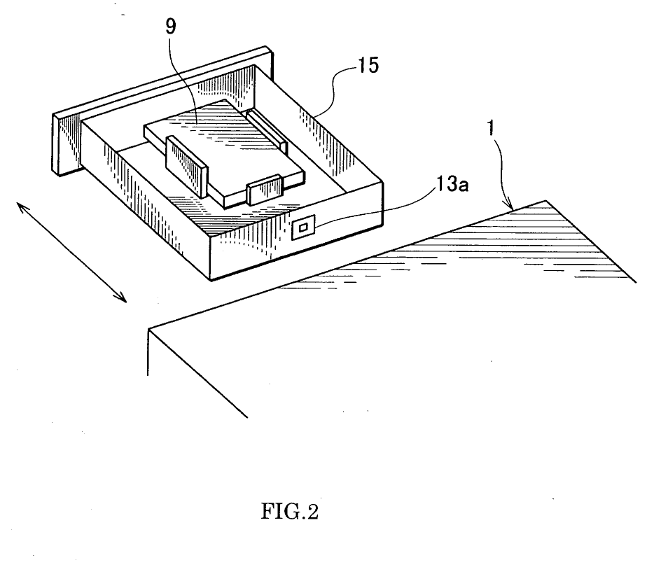

FIG. 2 illustrates that the paper feeding cassette 15 is withdrawn from the apparatus. The RFID 13a is mounted on the paper feeding cassette through an adhesive tape. When the paper feeding cassette 15 is inserted into the image forming apparatus 1, the RFID reader 11a mounted in the image forming apparatus body can read information necessary for a local setting stored in the RFID 13a.

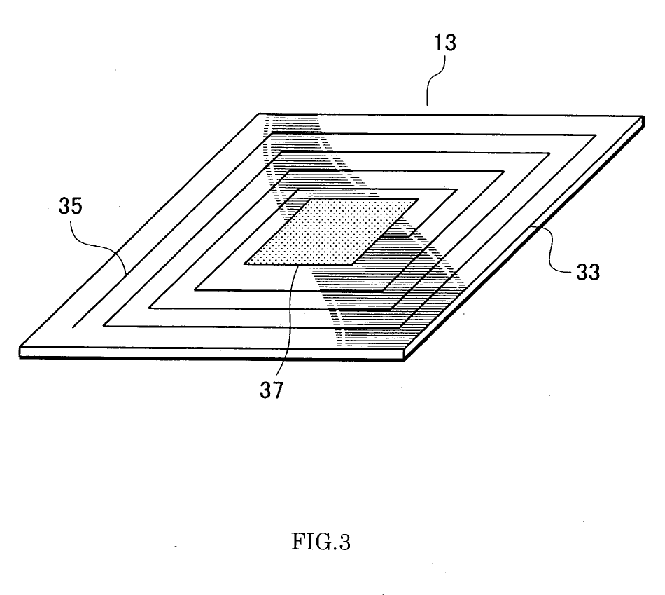

FIG. 3 explains the RFID as the memory device to be used in the present embodiment. The RFID 13 is composed of a label 33 having an adhesive surface, an antenna 35 of a loop shaped, and an IC memory 37 connected to the antenna 35. The IC memory 37 is composed of a nonvolatile ROM or a writable volatile memory such as EEPROM, a tuned circuit in which a data communication is performed by being tuned with an electromagnetic wave from the RFID reader 13 through the antenna 35 to thereby receive an electric power for the communication, a detection and rectifier circuit, a controlling circuit, and the others. There are various sizes of the RFID 13, for example, a size of several mm to several tens of mm per one side. The size of the RFID is selectable in accordance with a condition. Further, there are various effective distances of the RFID 13 in reading or writing, for example, a distance of several mm to several tens of mm. The distance is selectable in accordance with a positional relation between the RFID 13a and the RFID reader 11a. According to the first embodiment in FIG. 1, it is exemplified that the RFID 13a and the RFID reader 11a are positioned closely; however, the RFID reader 11a may be provided at least anywhere on the image forming apparatus.

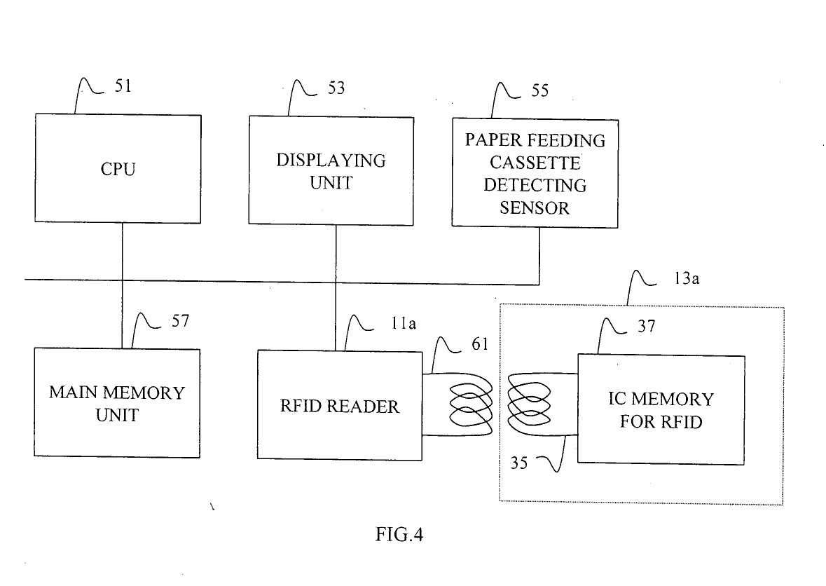

FIG. 4 is a block diagram of components in terms of reading the RFID of the image forming apparatus of the first embodiment according to the present invention. A functional block such as the printing unit is omitted. The image forming apparatus includes a CPU 51 for an information treatment, a display unit 53 for displaying an error message or the like, a paper feeding cassette detecting sensor 55 which detects a presence or an absence of the paper feeding cassette 15, a main memory unit 57 composed of a hard disc for storing information necessary for the information treatment and a semiconductor memory, a RFID reader 11a and an antenna 61 thereof, RFID 13a and an IC memory 37 composing the RFID 13a and an antenna 35 for RFID.

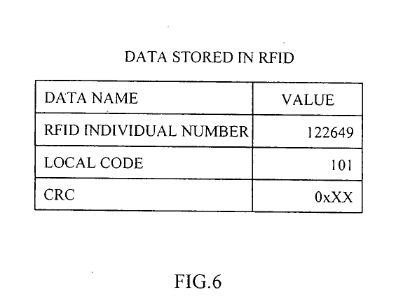

The RFID stores data such as a local code for performing the local setting (see FIG. 6, detailed description thereof will follow).

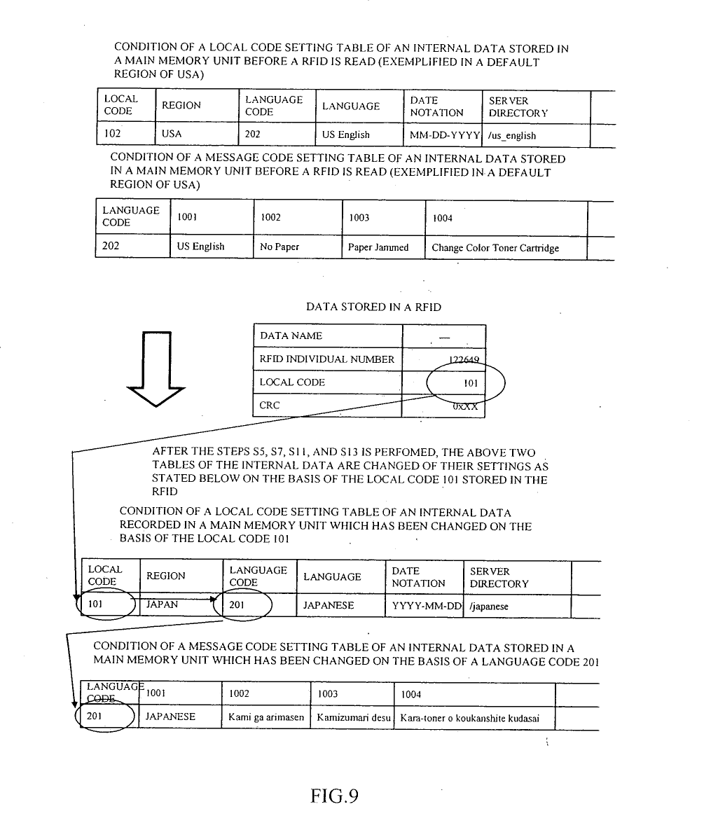

The main memory unit stores a local code setting table of an internal data in which stored is information as to by which local setting is used to perform the setting of the image forming apparatus, and a message code setting table of the internal data in which stored is information as to which message in what language is to be output (see FIG. 9, detailed explanation thereof will follow).

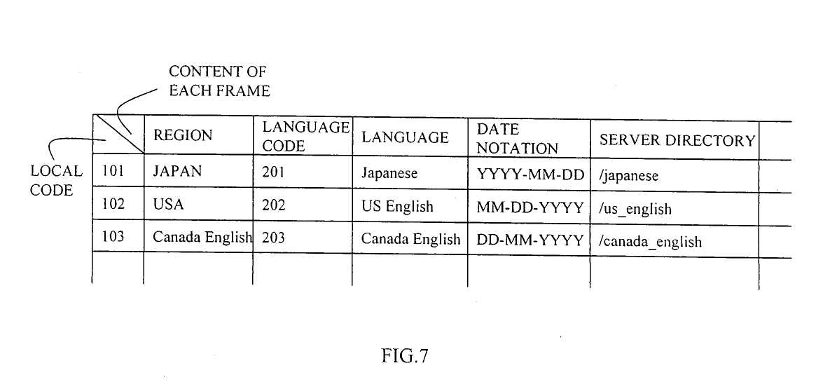

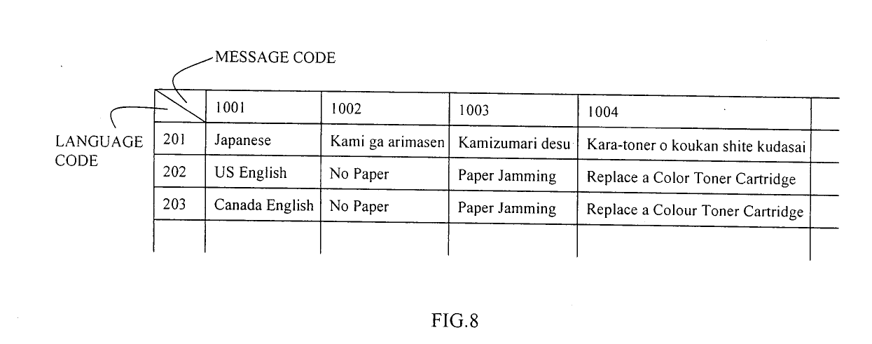

The main memory unit also stores a local code table including data of all regions where the image forming apparatus is used (see FIG. 7, detailed explanation thereof will follow), and a massage code table including a language message of all the regions as well (see FIG. 8, detailed explanation thereof will follow), the local code table and the massage code table being essential for recording the above stated setting table.

The RFID 13a, when a paper feeding cassette 15 is housed in the paper feeding cassette housing 8, performs a wireless communication between the RFID reader 11a mounted on the image forming apparatus body side and the RFID reader 11a through an antenna 61 thereof. Since the tuning circuit of the IC memory 37 of the RFID tunes to a frequency used by the RFID reader 11a and thereby the electric power necessary for reading and writing data is supplied from the RFID reader 11a through the antenna 61, 35, the RFID 13a advantageously does not require a connector or a wiring for connecting both any more.

Flow of Steps for Setting the Internal Data

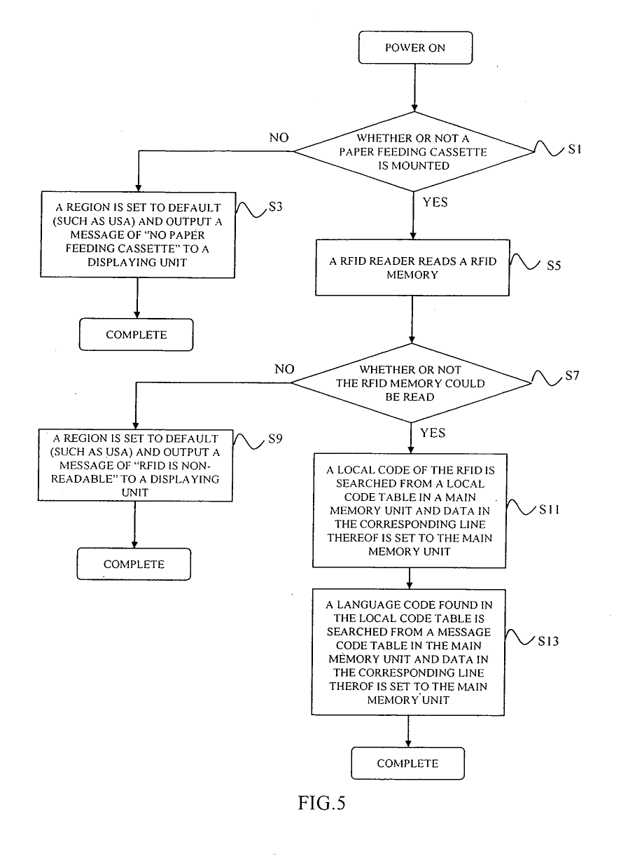

An explanation is made as to a flow of steps for setting the internal data according to the first embodiment with reference to FIG. 5.

When a power of the image forming apparatus is on, the paper supplying cassette detecting sensor 55 detects whether or not the paper supplying cassette is mounted to the image forming apparatus, and a step S1 in which the detection result is judged is performed.

When the judging result shows “NO”, the paper supplying cassette detecting sensor judges that the paper supplying cassette is not inserted in the image forming apparatus, and step S3 in which a message of “NO PAPER FEEDING CASSETTE” is displayed on a display of the display unit 53 in a language set by the local setting of the default is performed while the local setting of the internal data is left as it is preliminary set in the main memory unit, namely, a default setting (for example, USA), resulting in completing the setting.

When the judging result (S1) as to whether or not the paper feeding cassette is mounted to the image forming apparatus is “YES”, a step S5 in which the RFID reader 11a reads a content of the RFID 13 is performed.

Then, a step S7 in which a judgment is made as to whether or not the content of the RFID 13 could be read without failure is performed.

When the judging result shows “NO”, the RFID reader 11a judges that the information contained in the RFID is not readable, and thus a step 9 in which a massage of “RFID IS NON-READABLE” is displayed on the display of the display unit 53 in a language set by the local setting of the default setting is performed while the local setting of the internal data is left as it is priory set in the main memory unit, i.e., a default setting (such as USA), resulting in completing the setting.

Such case would seldom occur; however, this step is provided just in case where the RFID reader 11a is out of service or the RFID 13 is taken away from the paper supplying cassette.

A step in which the content of the RFID 13 could be read without failure is explained next. When the content of the RFID 13 (FIG. 6) is read without failure (when the judgment of S7 is “YES”), a value of the local code contained in the content of the RFID 13 is searched from the local code table (FIG. 7) stored in the main memory unit 57, and then a step S11 in which the local code table of the internal data for local setting in the corresponding line is set in the main memory unit is performed.

Then, a language code set in the aforementioned step, namely, the step S11, is searched from a message code table (FIG. 8) stored in the main memory unit 57, and then a step S13 in which the message table of the internal data for displaying the message in the corresponding line is set in the main memory unit is performed to complete the setting.

Detailed Explanation for Setting the Internal Data

Steps S5 to S13 in which rewriting of the above mentioned internal data is done will be explained into more details on the basis of actual values.

The RFID 13 stores the content as shown in FIG. 6. The RFID stores a RFID individual number for identifying the RFID, the local code for performing the local setting, and CRC (Cyclic Redundancy Check) sign to be used in a judgment as to whether or not the aforementioned data of the RFID could be read or written without failure. The main memory unit 57 of the image forming apparatus body stores the local code table as shown in FIG. 7 and the message code table as shown in FIG. 8.

The local code table (FIG. 7) includes date to be set region by region such as a notation system for noting a local name, a language code, a language, and a date (YYYY-MM-DD denotes year-month-day, and MM-DD-YYY denotes month-day-year, respectively.) and a directory name of a root directory for each language on the web server in the image forming apparatus body in order to be used in a communication with the administration terminal device. Actually, there are more setting items other than the above; however, only representative items are exemplified here for explanation of the present invention.

The massage code table (FIG. 8) includes a message in every language (“NO PAPER; 1002”, “PAPER JAMMMING” and so on) corresponding to the message code (for example, 1002 or 1003) indicating a condition of the apparatus sent from the printing unit of the image forming apparatus body. With regard to the message code table, only the representative items are listed similar to the above.

A process in which the local code setting table and the message code setting table in the internal data of the image forming apparatus are set is explained in FIG. 9 with a help of actual values.

A CPU 51 of the image forming apparatus performs a comparison between the local code read from the RFID 13 (corresponding to 101 in an example in FIG. 6) and the local code table stored in the main memory unit (FIG. 7), and write into the local code setting table of the internal data in the main memory unit 57 (S11) (FIG. 9) a line corresponding to the local code 101, namely, a content indicating that the region is Japan (the language code; 201), (the language; Japanese), (the date; YYYY-MM-DD), and (the server directory;/Japanese).

Then, on the basis of the language code 201 obtained in the above step, a line corresponding to the language code 201, namely, a content of the line indicating that the language is Japanese (1002; NO PAPER), (1003; PAPER JAMMING), (1004; CHANGE COLOR TONER) is written from the message code table in FIG. 8 into the massage code setting table of the internal date stored in the main memory unit 57 (S13) (FIG. 9).

As stated above, the local setting of the internal data of the image forming apparatus is changed to the setting for Japan which is stored in the RFID.

### Advantageous Effect of First Embodiment

According to the first embodiment of the present invention, only a preliminary attachment to the paper feeding cassette of the RFID which stores the local setting corresponding to the region where the apparatus is shipped eliminates a necessity of the setting for each region at the time the apparatus is shipped from the factory. The image forming apparatus starts up according to the setting corresponding to the region where the apparatus is used. Further, this eliminates a necessity of an initial setting in an unfamiliar language and an initial setting through the administration terminal device by the user of the apparatus.

According to the local setting and the language setting as set by the present invention, the image forming apparatus uses a language set on the basis of the information identified by the RFID when the image forming apparatus performs the report printing in which a condition of the apparatus is reported to the user and when the communication is performed between the apparatus and the administration terminal device.

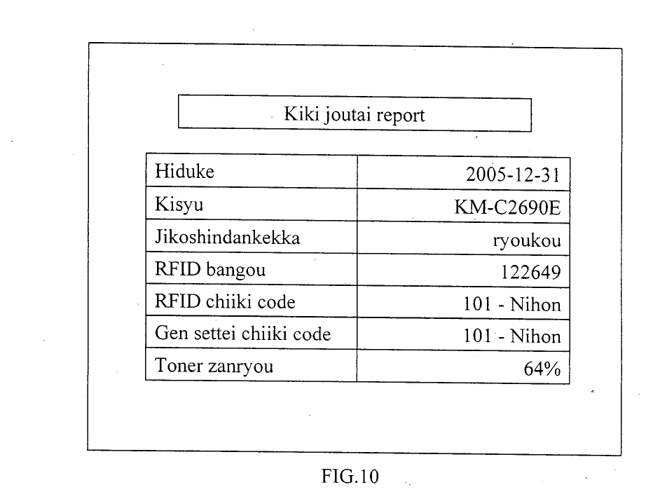

The advantageous effect of a case where the local setting and the language setting of the internal data is actually set is explained into details with an example of an output of the report. FIG. 10 illustrates a screen page of an output report of the apparatus in a case where the local setting is set to Japan. The screen page is printed in Japanese, and the date notation setting of the local code includes “year-month-day” data in this order for Japanese.

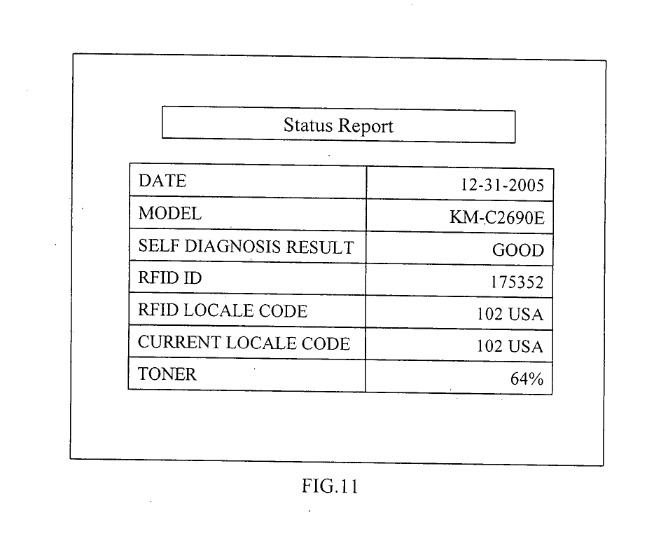

FIG. 11 illustrates a screen page of the output report of the apparatus in a case where the local setting is set to USA. The screen page is printed out in English, and the date notation setting of the local code includes “year-month-day” data in this order for USA.

For another example, the language setting in the communication between the apparatus and the administration terminal through a built-in web server will be explained below.

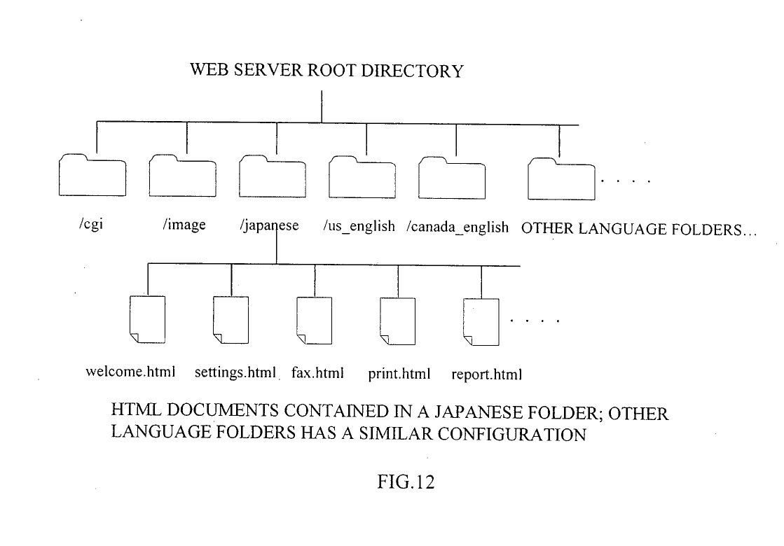

The image forming apparatus includes the built-in web server in order to localize the apparatus through a connection with the administration terminal. The content indicated by the built-in web server is preliminary prepared in a language corresponding to the region where the apparatus is used and is written in a folder for each language. FIG. 12 illustrates a directory configuration of the built-in web server. In directories lower than a root directory of the web server, there is prepared a CGI folder in which CGI for executing a program in the server is stored, an image folder in which images are stored, and a language folder for each language. The language folder holds therein HTML documents which indicates pages for functions such as a setting change (settings.html), a facsimile function (fax.html) and a printing function (print.html) setting, and an apparatus condition report (report.html). For example, an opening of the apparatus condition report (report.html) document results in a display of the screen page equivalent to the report output reporting the apparatus condition as in FIGS. 10 and 11 on the display of the administration terminal.

As it is already explained above in the flow of the steps in the step S11, since a server directory name for each language in the built-in web server in connection with each language is set on the basis of the data contained in the RFID, the report as illustrated in FIG. 10 is displayed on the display of the administration terminal if the language is set to Japanese, whereas, the report as illustrated in FIG. 11 is displayed on the display of the administration terminal if the language is set to US English, upon accessing to the built-in web server.

### Second Embodiment

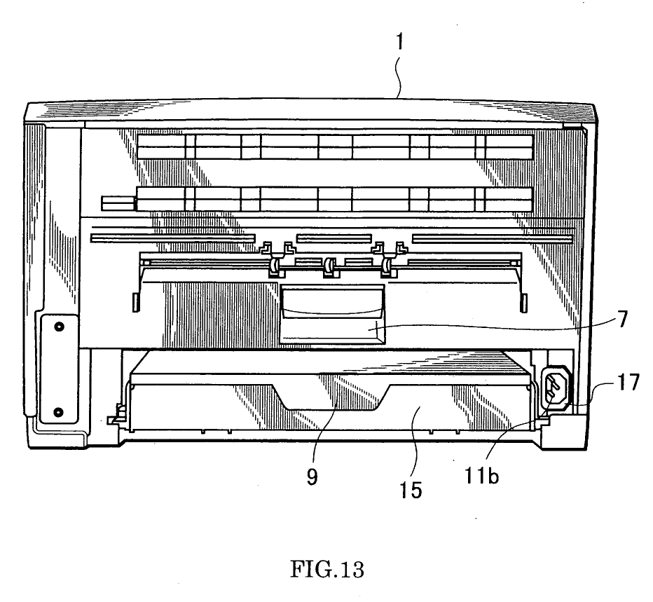

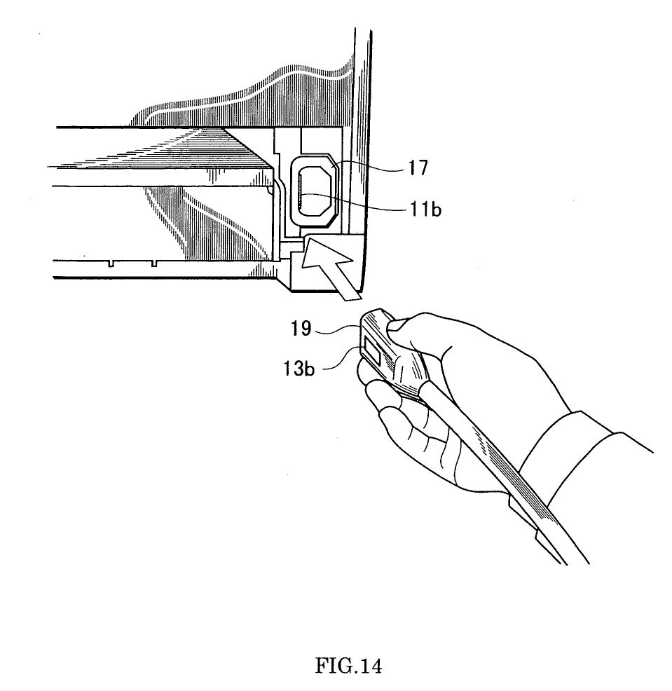

FIGS. 13 and 14 illustrate a second embodiment of the present invention. FIG. 13 is a view of the image forming apparatus in which the RFID reader 11b is attached to a side surface of the power source cable entry 17 of the apparatus. FIG. 14 is a view of the image forming apparatus in which the RFID 13b as the memory device of the present invention is attached to a side surface of the power source cable 19 of the apparatus.

Configuration of the Apparatus

The second embodiment is exemplified in a case where the RFID 13b as the detachable non-consumable member is attached to the power source cable 19.

The second embodiment employs the printing unit 3, the paper discharging tray 5, and the paper feeding unit 7 which are identical to those of the image forming apparatus 1 according to the first embodiment as illustrated in FIG. 1.

According to the second embodiment, the RFID 13b is attached to the side surface portion of a connector 19 of the power source cable, which is a detachable part, by means of an adhesive or the like as illustrated in FIG. 14. The RFID reader 11b for reading the RFID 13b is attached to the inside surface of the power source cable entry 17 by means of the adhesive or the like (FIGS. 13 and 14). Therefore, when the connector 19 is inserted into the power source cable entry 17, the RFID 13b faces to the RFID reader 11b to have the RFID 13b be readable by the RFID reader 11b.

### Flow of the Steps for Setting the Apparatus of the Second Embodiment

A flow of steps for setting the apparatus and the local setting and the language setting of the internal data according to the second embodiment are identical to what are explained in the first embodiment.

### Advantageous Effect of the Second Embodiment

The image forming apparatus according to the second embodiment can produce the same advantageous effect as the first embodiment just by a preliminary attachment of the RFID 13b, in which the language setting and the local setting corresponding to the shipping region is stored, to the side surface of the connector of the power source cable 19, and there is further advantage be produced that the local setting of the internal data of the apparatus body can be set without the operation through the operation panel or the administration terminal device.

Others

Examples of the freely detachable member can include a consumable member such as a toner cartridge.

The RFID is exemplified as the memory device here; however, a bar code or a two dimensional bar code can also produce the same advantageous effect.

### Third Embodiment

Configuration of the Apparatus

A third embodiment is exemplified in a case where the RFID as the detachable member is attached to the paper feeding cassette.

The apparatus configuration according to the third embodiment is identical to what is explained in the first embodiment with reference to FIG. 1, and therefore the explanation thereof is omitted here.

Further, the condition of the apparatus in which the RFID as the memory device is attached to the paper feeding cassette according to the third embodiment is also identical to what is explained in the first embodiment with reference to FIG. 2, and therefore the explanation thereof is omitted here.

Still further, the RFID as the memory device is also identical to what is explained in the first embodiment with reference to FIG. 3, and therefore the explanation thereof is omitted here.

Yet further, the block diagram of the components in connection with reading of the RFID of the image forming apparatus is identical to what is explained in the first embodiment with reference to FIG. 4, and therefore the explanation thereof is omitted here.

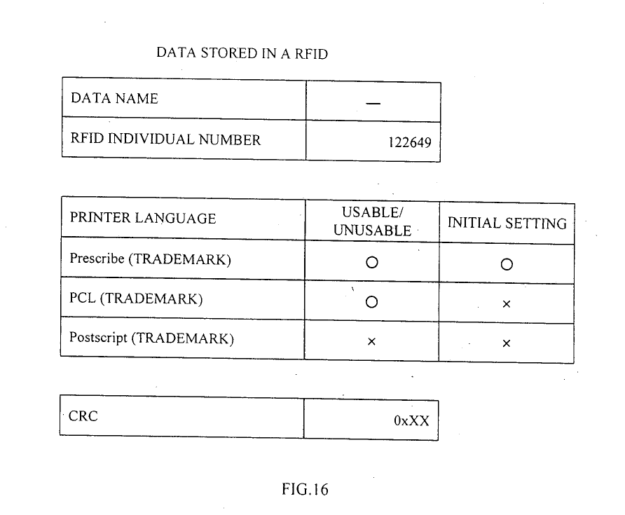

According to the third embodiment, the RFID stores data regarding which printer language is to be used (FIG. 16; will be explained later).

A Flow of Steps for Setting a Built-In Printer Language

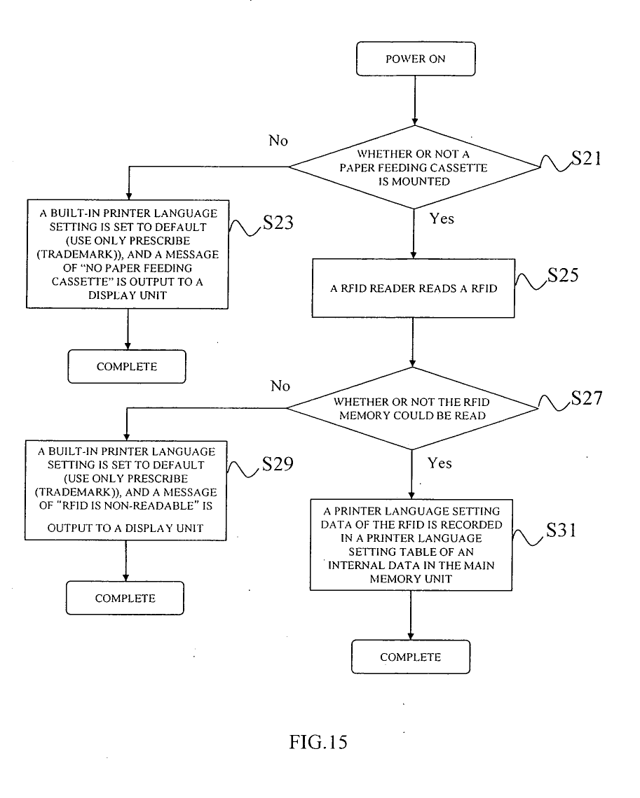

A flow of the Steps for setting a built-in printer language according to the third embodiment will be explained with reference to a flow chart in FIG. 15.

When the power source of the image forming apparatus is on, the paper feeding cassette detecting sensor 55 detects whether or not the paper feeding cassette is mounted to the image forming apparatus, resulting in performing a step S21 in which a result of the detection is judged.

When the detection result is “NO”, the paper feeding cassette detecting sensor judges that the paper feeding cassette is not inserted in the image forming apparatus and further judges that the information of the RFID is not readable, and therefore a step S23 in which a message of “NO PAPER FEEDING CASSETTE” is displayed on the display of the display unit 53 is performed while the printer language setting of the internal data is left as it is preliminary set in the main memory unit, namely, a default setting, (for example, only a PRESCRIBE (trademark) is used), resulting in completing the setting.

When the detection result as to whether or not the paper feeding cassette is mounted to the image forming apparatus (S21) is “YES”, a step S25 in which the RFID reader 11a reads the content of the RFID 13 is performed.

Then, a step S27 in which whether or no the content of the RFID 13 could be read without failure is judged is performed.

When the judging result is “NO”, the RFID reader 11a judges that the information of the RFID is not readable and thus a step S29 in which a message of “RFID NON-READABLE” is displayed on the display of the display unit 53 is performed while the printer language setting of the internal data is left as it is preliminary set in the main memory unit, namely, the default setting (for example, only the PRESCRIBE (trademark) is used), resulting in completing the setting.

Although such a case would seldom occur, this step is provided just in case where the RFID reader 11a is out of service or the RFID 13 is taken away from the paper feeding cassette.

Next, a step in which the content of the RFID 13 could be read without failure will be explained below. When the content of the RFID 13 (FIG. 16) is read without failure (when the judgment in the step S27 is “YES”), a step S31 in which the printer language setting data in the content is stored in the printer language setting table of the internal data in the main memory unit is performed to complete the setting.

The content of the actual settings in the step S31 will be explained with reference to the actual values.

Initially, the RFID 13 stores a content as shown in FIG. 16. The RFID individual number for identifying the RFID. Next, in the setting table regarding the printer language, PRESCRIBE (trademark) is used in the first line to set the usable language as the initial setting to the PRESCRIBE (trademark). PCL is used in the second line. Such an example of the 3 printer language is shown that POSTSCRIPT (trademark) is not used in the third line. The CRC (Cyclic Redundancy Check) sign used in judging whether or not the above stated RFID data could be read or written without failure is written in the printer language setting table.

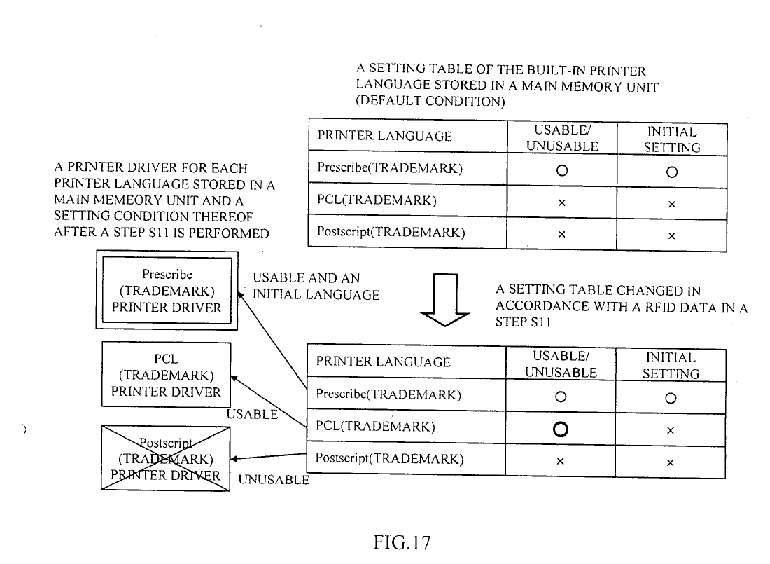

FIG. 17 illustrates a setting table of the built-in printer language, which is stored in the main memory unit 57 of the image forming apparatus 1 body, and a renewal condition thereof. As illustrated in FIG. 17, in the image forming apparatus 1, only the BRESCRIBE (trademark) is set as the usable printer language when the apparatus is shipped from the factory, and the printer language under the initial condition is set to the PRESCRIBE (trademark). In accordance with the step S31 as described above, the setting of the built-in printer language in the main memory unit is renewed according to the printer language setting of the RFID as shown in FIG. 16. As such, the setting is so renewed that the PCL is usable. Further, two corresponding drivers such as a PRESCRIBE (trademark) printer driver and a PCL printer driver are set to usable conditions (FIG. 17). The printer language at the initial setting is the PRESCRIBE (trademark) as well as the printer language before the RFID data is read.

### Advantageous Effect of the Third Embodiment

According to the third embodiment, only a preliminary attachment of the RFID which stores the printer language setting corresponding to a model and the shipped region of the image forming apparatus to the paper feeding cassette will enables a startup of the image forming apparatus according to the setting of the printer language set in the RFID without a necessity of setting of the model and the shipped region upon every shipment of the image forming apparatus from the factory. Further, necessities of the printer language setting through an unfamiliar operation panel and the printer language setting from the administration terminal device by the user of the image forming apparatus can be eliminated.

### Fourth Embodiment

Configuration of the Apparatus

A fourth embodiment is exemplified in a case where the RFID as the detachable non-consumable member is attached to the image forming apparatus.

A configuration of the apparatus according to the fourth embodiment is identical to what is explained in the first embodiment with reference to FIG. 1, and therefore the explanation thereof is omitted here.

Further, such a condition that the RFID as the memory device is attached to the paper feeding cassette is also identical to what is explained in the first embodiment with reference to FIG. 2, and therefore the explanation thereof is omitted here.

Still further, the RFID as the memory device is identical to what is explained in the first embodiment with reference to FIG. 3, and therefore, the explanation thereof is omitted here.

Yet further, the block diagram of the components in terms of reading the RFID of the image forming apparatus is also identical to what is explained in the first embodiment with reference to FIG. 4, and therefore the explanation thereof is omitted here.

According to the fourth embodiment, the RFID stores data regarding the local code for the local setting.

A Flow of the Steps for Setting the Internal Data

A flow of the steps for setting the internal data according to the fourth embodiment will be explained below with reference to a flow chart in FIG. 5.

When the power source of the image forming apparatus is on, the paper feeding cassette detecting sensor 55 detects whether or not the paper feeding cassette is mounted to the image forming apparatus, and the step S1 in which a result thereof is judged is performed.

When the judging result is “NO”, the paper feeding cassette detecting sensor judges that the paper feeding cassette is not inserted in the image forming apparatus and thus further judges that the information in the RFID is not readable. As such, the local setting of the internal data is left as it is preliminary set in the main memory unit, namely, the default setting (for example, USA), and the step S3 in which the message of “NO PAPER FEEDING CASSETTE” is displayed on the display of the display unit 53 in a language set by the setting of the default is performed to complete the setting.

When the judgment (S1) as to whether or not the paper feeding cassette is mounted to the image forming apparatus is “YES”, the step S5 in which the RFID reader 11a reads the content of the RFID 13 is performed.

Then, the step S7 in which whether or not the content of the RFID 13 could be read without failure is judged is performed.

When the judging result is “NO”, the paper feeding cassette detecting sensor 55 judges that the information of the RFID is not readable, the local setting of the internal data is left as it is preliminary set in the main memory unit, namely, the default setting (such as USA), and the step S9 in which the message of “RFID IS NON-READABLE” is displayed on the display of the display unit 53 in the language set by the local setting of the default setting is performed to complete the setting.

Although such case would seldom occur, this step is provided just in case where the RFID reader 11a is out of service or the RFID 13 is taken away from the paper feeding cassette.

Then, a step in which the content of the RFID 13 could be read without failure will be explained below. When the content of the RFID 13 (FIG. 6) is read without failure (when the judgment in the step S7 is “YES”), a value of the local code in the content is searched from the local code table (FIG. 7) stored in the main memory unit 57, and the step S11 in which the local code table of the internal data for local setting in a corresponding line is set in the main memory unit is performed.

Then, the language code set in the aforementioned step, namely, the step S11, is searched from the message code table (FIG. 8) stored in the main memory unit 57, and the step S13 in which the message table of the internal data for displaying the message corresponding to thus found line is set to the main memory unit is performed to complete the setting.

Detailed Description of the Setting of the Internal Data

The steps S5 to S13 in which the internal data is rewritten will be explained into details with reference to actual values.

Initially, the RFID 13 stores the content as shown in FIG. 6. The RFID individual number for identifying the RFID, the local code for local setting, and the CRC (Cyclic Redundancy Check) sign to be used in the judgment as to whether or no the aforementioned RFID data has been read or written without failure are written into the RFID 13. The local code table as shown in FIG. 7 and the message code table as shown in FIG. 8 are written in the main memory unit 57 of the image forming apparatus.

The local code table (FIG. 7) stores data, that requires setting region by region, such as the notation system for noting the local name, the language code, the language, the date, (YYYY-MM-DD represents year-month-day, MM-DD-YYYY denotes month-day-year), and the directory name of the root directory for each language of the web server in the image forming apparatus body to be used when the communication is made with the administration terminal device. Although there are a lot of setting items other than the above, only the representative items are exemplified for the explanation of the present invention.

The message code table (FIG. 8) stores the message in each language (“NO PAPER; 1002), (“PAPER JAMMING; 1003 and so on) corresponding to the message code indicating a condition of the apparatus (for example, 1002 and 1003) sent from the printing unit of the image forming apparatus. Also, only the representative items are exemplified in the message code table as well as the above.

FIG. 9 exemplifies, with reference to the actual values, the steps in which the local code setting table and the message code setting table of the internal data of the image forming apparatus are set.

The CPU 51 of the image forming apparatus compares the local code read from the RFID 13 (101 in the example of FIG. 6) with the local code table (FIG. 7) as stored in the main memory unit, and a line corresponding to the local code 101, namely, the content of the line indicating that the region is Japan (language code; 201), (language; Japanese), (date; YYY-MM-DD), and (server directory;/Japanese), is written into the local code setting table of the internal data of the main memory unit 57 (step S11) (FIG. 9).

Then, on the basis of thus obtained language code 201, the line corresponding to the language code 201 in the message code table in FIG. 8, namely, the content indicating that the language is Japanese (1002; NO PAPER), (1003; PAPER JAMMING), (1004; CHANGE COLOR TONER), is written into the message code setting table of the internal data of the main memory unit 57 (step S13) (FIG. 9).

In view of the above, the local setting of the internal data of the image forming apparatus is localized to the setting for Japan stored in the RFID.

### Advantageous Effect of the Fourth Embodiment

According to the fourth embodiment of the image forming apparatus, only a preliminary attachment to the paper feeding cassette of the RFID which stores the local setting corresponding to the shipped region enables a startup of the image forming apparatus according to the setting suitable to the region where the image forming apparatus is used without a necessity of setting for each region upon shipment of the apparatus from the factory. Further, it is no more required for the user of the image forming apparatus to perform the initial setting in an unfamiliar language through an operation panel and the initial setting through the administration terminal device.

According to the local setting and the language setting according to the setting of the present invention, the image forming apparatus uses the language that is set on the basis of the information as identified by the RFID when the image forming apparatus performs a report printing for reporting a condition thereof and makes communication with the administration terminal device.

The advantageous effect produced when the local setting and the language setting of the internal data are actually done is explained with an example of output of the internal report. FIG. 10 shows a screen page including an internal report output from the apparatus of which local setting is set for Japan. The screen page is printed in Japanese, and the date notation of the local code is indicated in an order of “year-month-day” for Japan.

FIG. 11 is a screen page of an internal report of the apparatus of which local setting is set for the USA. The screen page is printed in English and the date notation of the local code is indicated in an order of “month-day-year” for the USA.

For further example, the language setting in the communication between the apparatus and the administration terminal through the built-in web server will be explained below.

The image forming apparatus includes the built-in web server in order to perform an internal setting thereof by connecting the apparatus with the administration terminal. The content displayed in the built-in web server is written and preliminary made in the language corresponding to the region to be written in the folder for each language. FIG. 12 illustrates the directory configuration of the built-in web server. There is prepared a CGI folder in which CGI is stored in order to execute a program in the server, an image folder for storing images, and a language folder for each language in directories lower than the root directory of the web server. The language folder stores HTML documents which represent pages for each function such as the change of settings (settings.html), the facsimile function (fax.html) and the printing function (print.html) setting, and the apparatus condition report (report.html). For example, by opening the apparatus condition report (report.html), a screen page equivalent to the report output which reports the apparatus condition in FIGS. 10 and 11 is displayed on the display of the administration terminal.

As already explained in the step S11 as to the flow of the steps, since the server directory name for each language of built-in web server which corresponds to each language is set on the basis of the data of the RFID, the report as shown in FIG. 10 is displayed on the display of the administration terminal when the language is set to Japanese as well as the report as shown in FIG. 11 is displayed on the display of the administration terminal when the language is set to US English upon an access with the built-in web server.

### Fifth Embodiment

Configuration of the Apparatus

A fifth embodiment is exemplified in a case where the RFID as the detachable member is attached to the paper feeding cassette.

A fifth embodiment is exemplified in a case where the RFID as the detachable non-consumable member is attached to the paper feeding cassette.

Since a configuration of the apparatus according to the fifth embodiment is identical to what is explained in the first embodiment with reference to FIG. 1, the explanation thereof is omitted here.

Further, since a condition that the RFID as the memory device is attached to the paper feeding cassette is identical to what is explained in the first embodiment with reference to FIG. 2, the explanation thereof is omitted here.

Still further, since the RFID as the memory device is identical to what is explained in the first embodiment with reference to FIG. 3, the explanation thereof is omitted here.

Yet further, since a block diagram of the components in terms of reading the RFID of the image forming apparatus is identical to what is explained in the first embodiment with reference to FIG. 4, the explanation thereof is omitted here.

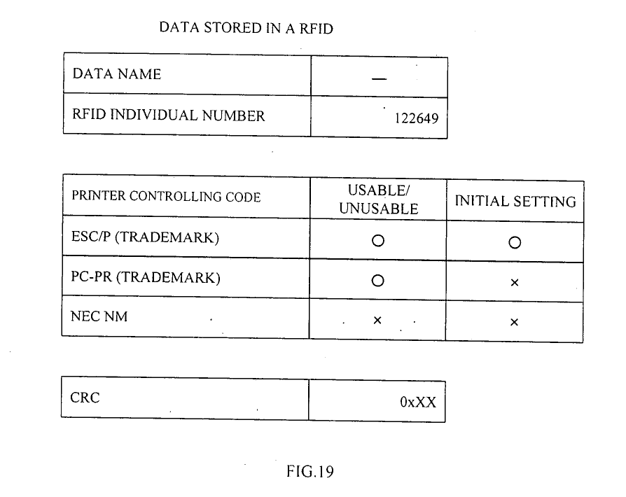

According to the fifth embodiment, the RFID stores data containing information as to which printer controlling code is to be used (FIG. 19; will be explained into details).

A Flow of the Steps for Setting The Built-In Printer Controlling Code

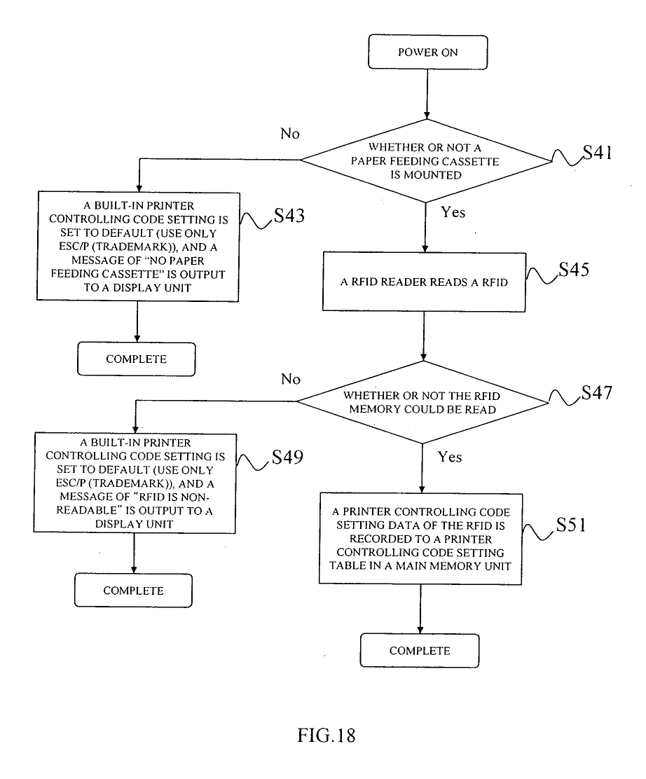

A flow of steps for setting the built-in printer controlling code is explained with reference to a flow chart in FIG. 18.

When the power source of the image forming apparatus is turned on, the paper feeding cassette detecting sensor 55 detects whether or not the paper feeding cassette is mounted to the image forming apparatus, and a step S41 in which a result thereof is judged is performed.

When the judging result is “NO”, the paper feeding cassette detecting sensor judges that the paper feeding cassette is not mounted to the image forming apparatus and thus information of the RFID is not readable. As such, a step 43 in which a message of “NO PAPER FEEDING CASSETTE” is displayed on the display of the display unit 53 is performed while the printer controlling code setting in the internal data is left as it is preliminary set in the main memory unit, namely, the default setting, (for example, only use ESC/P (trademark)).

When the result of judgment (S41) as to whether or not the paper feeding cassette is mounted to the image forming apparatus is “YES”, a step S45 in which the RFID reader 11a reads the content of the RFID 13 is performed.

Then, a step S47 in which whether or not the content of the RFID 13 is read without failure is judged is performed.

When the result of judgment is “NO”, the RFID reader judges that the information of the RFID is not readable, and a step S49 in which a massage of “RFID IS NON-READABLE” is displayed on the display of the displaying unit 53 is performed while the printer controlling code setting of the internal data is left as it is preliminary set in the main memory unit, namely, the default setting (for example, use only ESC/P (trademark)), resulting in completing the setting.

Although such a case would seldom occur, this step is provided just in case where the RFID reader 11a is out of service or the RFID 13 is taken away from the paper feeding cassette.

Then, a case where the content of the RFID 13 is read without failure will be explained below. When the content of the RFID 13 (FIG. 19) is read without failure (When the judging result in the step S47 is “YES”), a step S51 in which the printer controlling code setting data contained in the content is stored in the printer controlling code setting table of the internal data in the main memory unit is performed to complete the setting.

The content to be actually set in the step S51 is explained below with reference to the actual values.

Initially, the RFID 13 stores a content in FIG. 19. The RFID individual number for identifying the RFID. Then, in the setting table of the printer controlling code, ESC/P (trademark) is used in the first line and a language in the initial setting is set to ESC/P (trademark). PC-PR (trademark) is used in the second line. In the third line, setting example indicating that the NEC NM is not used is shown with regard to the 3 printer controlling code. Further, the CRC (Cyclic Redundancy Check) sign which is used to judge whether or not the above stated RFID data is read without failure is written in the table.

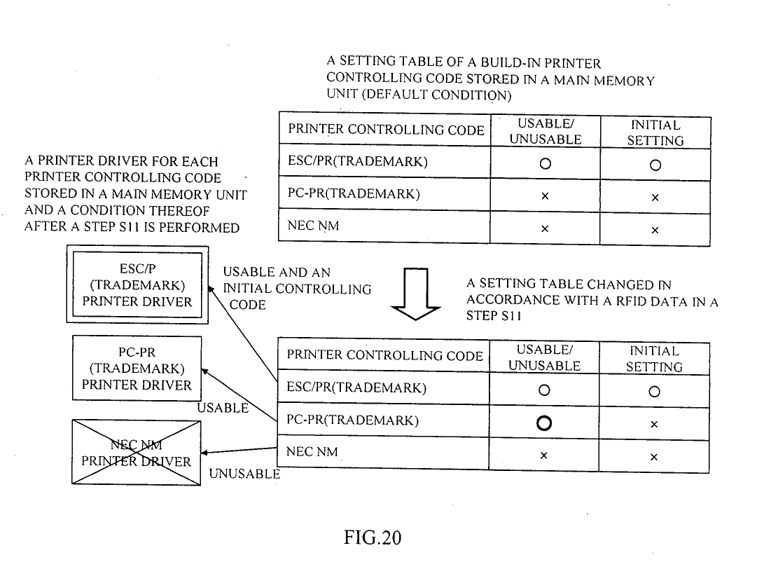

FIG. 20 illustrates a setting table of the built-in printer controlling code recorded in the main memory unit 57 of the image forming apparatus 1 body and how to renew thereof. As shown in FIG. 20, in the image forming apparatus upon a shipment thereof, only the ESC/P (trademark) is set as a printer controlling code, and the printer controlling code at an initial condition is set to the ESC/P (trademark). The setting of the built-in printer controlling code stored in the main memory unit is renewed in accordance with the printer controlling code setting of the RFID as shown in FIG. 19 in the step S51 as described above. As such, the setting is renewed, and therefore the PC-PR (trademark) becomes usable. Further, the corresponding two printer drivers such as the ESC/P (trademark) printer driver and the PC-PR (trademark) printer driver are set to usable conditions (FIG. 17). For the printer controlling code in the initial setting, the ESC/P (trademark) is set as it is before the RFID data is read.

### Advantageous Effect of the Fifth Embodiment

According to the fifth embodiment, only the attachment to the paper feeding cassette of the RFID in which the printer controlling code setting corresponding to a model and a shipped region of the image forming apparatus is stored eliminates the necessity of settings of the model and the shipped region upon shipment of the image forming apparatus from the factory, resulting in enabling a startup of the image forming apparatus according to the setting of the printer controlling code stored in the RFID.

What is claimed is:

1. An image forming apparatus with a memory device which performs an internal local setting of the apparatus including an apparatus body for producing a function corresponding to a region according to a local setting of an internal data and a member detachable to the apparatus body as required, in which the member is attached to the apparatus body in order to output an image forming data, the image forming apparatus comprising:
a memory device for storing information necessary for the local setting, the memory device being attached to the member; and
a reader for reading the memory device, the reader being attached to the apparatus body;
wherein the reader reads the information stored in the memory device when the member is attached to the apparatus body to perform the local setting with thus read information.

2. The image forming apparatus with the memory device which performs the internal local setting of the apparatus as claimed in claim 1, wherein the local setting is an internal language setting.

3. The image forming apparatus with the memory device which performs the internal local setting of the apparatus as claimed in claim 2, wherein the internal language setting is either one of a setting of language for report printing that reports a condition of the image forming apparatus or a setting of language for making a communication between the image forming apparatus and an external terminal device.

4. The image forming apparatus with the memory device which performs the internal local setting of the apparatus as claimed in claim 1, wherein the memory device is a RFID.

5. The image forming apparatus with the memory device which performs the internal local setting of the apparatus as claimed in claim 2, wherein the memory device is a RFID.

6. The image forming apparatus with the memory device which performs the internal local setting of the apparatus as claimed in claim 3, wherein the memory device is a RFID.

7. An image forming apparatus with the memory device which performs a built-in printer language setting of the apparatus including an apparatus body for performing an output that corresponds to a printer language according to a printer language setting of the internal data and a member that is detachable to the apparatus body as required, in which the member is attached to the apparatus body in order to output an image forming data, the image forming apparatus comprising:
a memory device for storing information necessary for the printer language setting, the memory device being attached to the member; and
a reader for reading the memory device, the reader being attached to the apparatus body;
wherein the reader reads information stored in the memory device when the member is attached to the apparatus body to perform the printer language setting with thus read information.

8. The image forming apparatus with the memory device which performs the built-in printer language setting of the apparatus as claimed in claim 7, wherein the internal printer language is any one of a PRESCRIBE (trademark), a PCL, or a POSTSCRIPT (trademark).

9. The image forming apparatus with the memory device which performs the built-in printer language setting of the apparatus as claimed in claim 7, wherein the memory device is a RFID.

10. The image forming apparatus with the memory device which performs the built-in printer language setting of the apparatus as claimed in claim 8, wherein the memory device is a RFID.

11. An image forming apparatus with the memory device which performs an internal data setting of the apparatus including an apparatus body for producing a function according to an internal data setting and a non-consumable member that is detachable to the apparatus body as required, in which the non-consumable member is attached to the apparatus body in order to output an image forming data, the image forming apparatus comprising;
a memory device for storing information necessary for the internal data setting, the memory device being attached to the non-consumable member; and
a reader for reading the memory device, the reader being attached to the apparatus body;
wherein the reader reads information stored in the memory device when the non-consumable member is attached to the apparatus body to perform the internal data setting with thus read information.

12. The image forming apparatus with the memory device which performs the internal data setting of the apparatus as claimed in claim 11, wherein the detachable non-consumable member is either one of a paper feeding cassette or a power source cable.

13. The image forming apparatus with the memory device which performs the internal data setting of the apparatus as claimed in claim 11, wherein the memory device is a RFID.

14. The image forming apparatus with the memory device which performs the internal data setting of the apparatus as claimed in claim 12, wherein the memory device is a RFID.

15. An image forming apparatus with the memory device which performs a built-in printer controlling code setting of the apparatus including an apparatus body for outputting data corresponding to a printer controlling code according to a printer controlling code setting of an internal data and a member that is detachable to the apparatus body as required, in which the member is attached to the apparatus body in order to output an image forming data, the image forming apparatus comprising:
a memory device for storing information necessary for the printer controlling code setting, the device being attached to the member; and
a reader for reading the memory device, the reader being attached to the apparatus body;
wherein the reader reads information stored in the memory device when the member is attached to the apparatus body to perform the printer controlling code setting with thus read information.

16. An image forming apparatus with the memory device which performs the built-in printer controlling code setting as claimed in claim 15, wherein the built-in printer controlling code is any one of the ESC/P (trademark), PC-PR (trademark), or NEC NM.

17. An image forming apparatus with the memory device which performs the built-in printer controlling code setting as claimed in claim 15, wherein the memory device is a RFID.

18. An image forming apparatus with the memory device which performs the built-in printer controlling code setting as claimed in claim 16, wherein the memory device is a RFID.
